(19) United States
(12) Patent Application Publication
(10) Pub. No.: US 2007/0033044 A1
(43) Pub. Date: Feb. 8, 2007

(54) System and method for creating generalized tied-mixture hidden Markov models for automatic speech recognition

(75) Inventor: Kaisheng N. Yao, Dallas, TX (US)

Correspondence Address: TEXAS INSTRUMENTS INCORPORATED, P O BOX 655474, M/S 3999, DALLAS, TX, 75265, US

(73) Assignee: Texas Instruments, Incorporated, Dallas, TX (US)

(21) Appl. No.: 11/196,601

(22) Filed: Aug. 3, 2005

(51) Int. Cl. G10L 15/14

(52) U.S. Cl. 704/256.3

(57) ABSTRACT

A system for, and method of, creating generalized tied-mixture hidden Markov models (HMMs) for noisy automatic speech recognition. In one embodiment, the system includes: (1) an HMM estimator and state tyer configured to perform HMM parameter estimation and state-tying with respect to word transcriptions and a pronunciation dictionary to yield continuous-density HMMs and (2) a mixture tyer associated with the HMM estimator and state tyer and configured to tie Gaussian mixture components across states of the continuous-density HMMs and a phone confusion matrix thereby to yield the generalized tied-mixture HMMs.

### CROSS-REFERENCE TO RELATED APPLICATION

The present invention is related to U.S. Patent Application No. [Attorney Docket No. TI-39862] by Yao, entitled “System and Method for Noisy Automatic Speech Recognition Employing Joint Compensation of Additive and Convolutive Distortions,” filed concurrently herewith, commonly assigned with the present invention and incorporated herein by reference.

### TECHNICAL FIELD OF THE INVENTION

The present invention is directed, in general, to speech recognition and, more specifically, to a system and method for creating generalized tied-mixture hidden Markov models (HMMs) for noisy automatic speech recognition (ASR).

### BACKGROUND OF THE INVENTION

Over the last few decades, the focus in ASR has gradually shifted from laboratory experiments performed on carefully enunciated speech received by high-fidelity equipment in quiet environments to real applications having to cope with normal speech received by low-cost equipment in noisy environments.

Some applications for ASR, including mobile applications, have only limited computational capability. Therefore, in addition to high accuracy and robust performance, low complexity is often a further requirement. The recognition accuracy of ASR in real applications is however much lower than that of read speech in quiet environments. The higher error rate is in part due to the environment variations, such as background noise, and also due to pronunciation variations. Environmental variations change the spectral shape of acoustic features. Variations of speaking rate and accent lead to phonetic shifts and phone reduction and substitution. (A phone is the smallest identifiable unit of sound found in a stream of speech in any language.)

Dealing with variations is important for practical systems. Methods have been proposed that explicitly incorporate variations into acoustic models. These include lexicon modeling at the phone level (see, e.g., Maison, et al., “Pronunciation Modeling for Names of Foreign Origin,” in ASRU, 2003), sharing Gaussian mixture components at the state level (see, e.g., Liu, et al., “State-Dependent Phonetic Tied-mixtures with Pronunciation Modeling for Spontaneous Speech Recognition,” IEEE Trans. on Speech and Audio Processing, vol. 12, no. 4, pp. 351-364, 2004; Saraclar, et al., “Pronunciation Modeling by Sharing Gaussian Densities Across Phonetic Models,” Computer Speech and Language, vol. 14, pp. 137-160, 2004; Yun, et al., “Stochastic Lexicon Modeling for Speech Recognition,” IEEE signal processing letters, vol. 6, no. 2, pp. 28-30, 1999; and Luo, et al., “Probabilistic Classification of HMM States for Large Vocabulary Continuous Speech Recognition,” in ICASSP, 1999, pp. 353-356) and Gaussian mixture component adaptation (see, e.g., Kam, et al., “Modeling Cantonese Pronunciation Variations by Acoustic Model Refinement,” in EUROSPEECH, 2003, pp. 1477-1480).

In mixture sharing techniques, the HMM states of the phone's model are allowed to share Gaussian mixture components with the HMM states of the models of the alternate pronunciation realization. It is well known that incorporation of variation at the state level is more effective than lexicon modeling (e.g., Saraclar, et al., supra). The more recent mixture adaptation techniques (e.g., Kam, et al., supra) provide a performance that is comparable to the other mixture sharing techniques described above, but require less memory.

However, the above-described techniques involving the sharing of Gaussian mixture components are amenable to significant further improvement, since variations may arise from more than just pronunciations. What is needed in the art is an ASR technique that adapts to a variety of variations and therefore yields a higher recognition rate than the techniques of the prior art. What is further needed in the art is a system and method for creating a generalized HMM that yields improved ASR. What is still further needed in the art is a system and method that are performable with limited computing resources, such as may be found in a digital signal processor (DSP) operating in a mobile environment.

### SUMMARY OF THE INVENTION

To address the above-discussed deficiencies of the prior art, the present invention provides a system for creating generalized tied-mixture HMMs for noisy automatic speech recognition. In one embodiment, the system includes: (1) an HMM estimator and state tyer configured to perform HMM parameter estimation and state-tying with respect to word transcriptions and a pronunciation dictionary to yield continuous-density HMMs and (2) a mixture tyer associated with the HMM estimator and state tyer and configured to tie Gaussian mixture components across states of the continuous-density HMMs and a phone confusion matrix thereby to yield the generalized tied-mixture HMMs.

In another aspect, the present invention provides a method of creating generalized tied-mixture HMMs for noisy automatic speech recognition. In one embodiment, the method includes: (1) performing HMM parameter estimation and state-tying with respect to word transcriptions and a pronunciation dictionary to yield continuous-density HMMs and (2) tying Gaussian mixture components across states of the continuous-density HMMs and a phone confusion matrix thereby to yield the generalized tied-mixture HMMs.

In yet another aspect, the present invention provides a DSP. In one embodiment, the DSP includes data processing and storage circuitry controlled by a sequence of executable instructions configured to: (1) perform HMM parameter estimation and state-tying with respect to word transcriptions and a pronunciation dictionary to yield continuous-density HMMs and (2) tie Gaussian mixture components across states of the continuous-density HMMs and a phone confusion matrix thereby to yield the generalized tied-mixture HMMs.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a high level schematic diagram of a wireless telecommunication infrastructure containing a plurality of wireless telecommunication devices within which the system and technique of the present invention can operate;

FIG. 2 illustrates a state diagram showing the sharing of Gaussian mixture components between adjacent phones “ax” and “er;”

FIG. 3 illustrates a high-level block diagram of a DSP located within at least one of the wireless telecommunication devices of FIG. 1 and containing one embodiment of a system for creating generalized tied-mixture HMMs for noisy ASR constructed according to the principles of the present invention;

FIG. 4 illustrates a flow diagram of one embodiment of a method of creating generalized tied-mixture HMMs for noisy ASR carried out according to the principles of the present invention; and

FIGS. 5A and 5B together illustrate linear and logarithmic plots comparing the power density function (PDF) of generalized tied-mixture HMMs constructed according to the principles of the present invention and the PDF of baseline single-component HMMs.

### DETAILED DESCRIPTION

As has been stated above, the prior art techniques involving the sharing of Gaussian mixture components may be improved since variations arise from more than just pronunciations. Moreover, the above-described techniques for incorporating variation (e.g., Liu, et al., and Saraclar, et al., supra) usually result in large acoustic models, which are prohibitive for mobile devices with limited computing resources.

Rather than only using pronunciation variation to select candidates for mixture sharing (e.g., Liu, et al., Saraclar, et al., and Yun, et al., supra), the technique of the present invention also uses a statistical distance measure to select candidates.

Before describing a specific embodiment of the technique of the present invention, one environment will be described within which the technique of the present invention can advantageously function. Accordingly, referring initially to FIG. 1, illustrated is a high level schematic diagram of a wireless telecommunication infrastructure, represented by a cellular tower 120, containing a plurality of mobile telecommunication devices 110a, 110b within which the system and method of the present invention can operate.

One advantageous application for the system or method of the present invention is in conjunction with the mobile telecommunication devices 110a, 110b. Although not shown in FIG. 1, today's mobile telecommunication devices 110a, 110b contain limited computing resources, typically a DSP, some volatile and nonvolatile memory, a display for displaying data and a keypad for entering data.

Certain embodiments of the present invention described herein are particularly suitable for operation in the DSP. The DSP may be a commercially available DSP from Texas Instruments of Dallas, Tex. An embodiment of the technique of the present invention in such a context will now be described, with the understanding that the technique may be used to advantage in a wide variety of applications.

The product of the illustrated embodiment of the technique of the present invention will hereinafter be referred to as “Generalized Tied-mixture HMMs,” or GTM-HMMs. GTM-HMMs are based on both the state tying and mixture tying for an efficient complexity reduction of triphone models. Compared to a pure mixture tying system such as semi-continuous HMMs (see, e.g., Huang, et al., Hidden Markov Models for Speech Recognition, Edinburgh University Press, 1990), GTM-HMMs use state tying to reserve the state identity. Compared to sole-state tying, GTM-HMMs share Gaussian mixture components across states even though these states may belong to different models. GTM-HMMs generalize state-dependent phonetic tied-mixture HMMs (PTM-HMMs) (see, e.g., Liu, et al., supra) in that a data-driven approach is used to select tied-mixtures.

A two-stage process is employed to train GTM-HMMs. The first stage does state tying and the second stage does mixture tying.

State tying is usually achieved by decision-tree-based state tying or data-driven state tying (see, e.g., Young, The HTK Book, Cambridge University, 2.1 edition, 1997). In the decision-tree-based state tying, decision trees are phonetic binary trees in which a yes/no phonetic question is attached to each node. Initially, all states in a given item list, typically a specific phone state position, are placed at the root node of a tree. Depending on each answer, the pool of the states is successively split and this continues until the states have trickled down to leaf nodes. All states in the same leaf node are then tied.

This set of phonetic questions is based on phonetic knowledge and is regarded as tying rules. The question at each node is chosen to maximize the likelihood of the training data, given the final set of tied states. In this tree structure, the root of each decision tree is a basic phonetic unit with a certain state topological location, triphone variants with the same central phone but different contextual phones are clustered to different leaf nodes according to the tying rules. In the data-driven state tying, states are clustered according to an inter-state distance measure (see, Young, et al., supra).

After the state tying, each state may have a limited number of Gaussian mixture components. Further performance improvement may be achieved by increasing Gaussian mixture components of each state. However, this may result in very large acoustic models that are prohibitive for mobile devices, in which computing resources are limited. In order to avoid large acoustic models, a mixture tying technique that significantly improves performance without increase model complexity will now be presented.

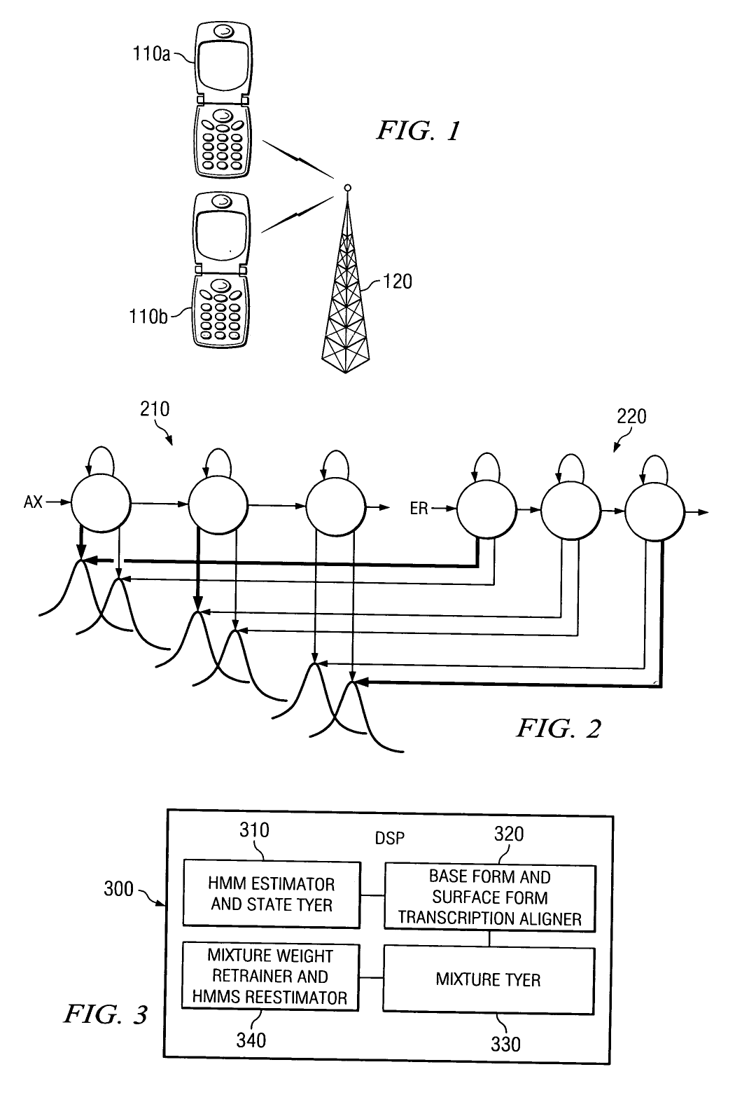

Turning now to FIG. 2, illustrated is a state diagram showing the sharing of Gaussian mixture components between adjacent phones “ax” 210 and “er” 220. The ability to discriminate phones is attained by: (1) using different mixture weights and (2) sharing different Gaussian mixture components with other states. The various states of the state diagram will not be explained, as they are generic and understood by those skilled in the pertinent art. FIG. 2 is presented primarily for the purpose of graphically illustrating how Gaussian mixture components are shared by multiple phones.

In addition to sharing, data-driven or knowledge-based selection techniques can also be used. These techniques are introduced for the aim of (1) reducing number of shared mixtures and (2) incorporating knowledge such as pronunciation variations.

In one embodiment, the technique of the present invention uses the well-known Bhattacharyya distance to measure Gaussian mixture component distance. Given two Gaussian mixture components, G₁(μ₁,Σ₁) and G₂(μ₂,Σ₂), the Bhattacharyya distance is defined as:

$$D ( {G}_{1} , {G}_{2} ) = \frac{1}{8} {( {μ}_{1} - {μ}_{2} )}^{T} {( \frac{{\sum }_{1} + {\sum }_{2}}{2} )}^{- 1} \times ( {μ}_{1} - {μ}_{2} ) + \frac{1}{2} ln \frac{\vert ( {\sum }_{1} + {\sum }_{2} ) / 2 \vert}{{\vert {\sum }_{1} \vert}^{1 / 2} \cdot {\vert {\sum }_{2} \vert}^{1 / 2}} . \qquad ( 1 )$$

where μ and Σ are the mean and variance of a Gaussian mixture component, respectively.

A state then enlarges its set of Gaussian mixture components with the Gaussian mixture components of other states having the smallest Bhattacharyya distances. As a result, these newly included power density functions, or PDFs, are tied to other states in possibly different models. Then, weight of PDF c in a state s are re-initialized to:

$${w}_{sc} = \{ \begin{matrix}{d}_{t} & if c ∈ \{ 1 , … {K}_{s} \} \\ \frac{1 - {d}_{t} {K}_{s}}{K - {K}_{s}} & otherwise\end{matrix} \qquad ( 2 )$$

where dₜ=min(0.9/Kₛ, 2/K), K and Kₛ are the number of Gaussian mixture components of the new state and the old state, respectively.

In the illustrated embodiment, pronunciation variation is first analyzed. Canonical pronunciations of words are obtained manually or from data-driven techniques, such as a decision-tree-based pronunciation model (see, e.g., Suontausta, et al., “Low Memory Decision Tree Technique for Text-to-Phoneme Mapping,” in ASRU, 2003).

A Viterbi alignment process may then employed to obtain a confusion matrix of phone substitution, insertion and deletion, by comparison of canonical pronunciation with alternate pronunciations. Given a state in a phone, Gaussian mixture components are advantageously selected only from those in states of alternate phones.

The Bhattacharyya distance may then be used to measure Gaussian mixture component distance and to append those components with the smallest Bhattacharyya distances. Mixture weights may be re-initialized by Equation (2).

The parameters of the reconstructed model can be estimated in much the same way as conventional state-tying/mixture-tying parameters are estimated using the well-known Baum-Welch EM algorithm (see, e.g., L. R. Rabiner, “A Tutorial on Hidden Markov Models and Selected Applications in Speech Recognition,” in proceedings of the IEEE, 77(2), 1989, pp. 257-286).

Having described GTM-HMM in general, a system embodying GTM-HMM can be described. Accordingly, turning now to FIG. 3, illustrated is a high-level block diagram of a DSP 300 located within at least one of the wireless telecommunication devices 110a, 110b of FIG. 1 and containing one embodiment of a system for creating generalized tied-mixture HMMs for noisy ASR constructed according to the principles of the present invention.

The system contains an HMMs estimator and state tyer 310. The HMMs estimator and state tyer 310 is configured to perform HMMs parameter estimation and state-tying. The illustrated embodiment of the HMMs estimator and state tyer 310 performs HMMs estimation by the E-M algorithm. State tying may be applied via decision-tree or data-driven approaches. The HMMs estimator and state tyer 310 generates continuous-density HMMs, or CD-HMMs.

The system further contains a base form and surface form transcription aligner 320 associated with the HMMs estimator and state tyer 310 and configured to align base and surface form transcriptions. The illustrated embodiment of the base form and surface form transcription aligner 320 takes the form of a dynamic programming alignment tool using the well-known Viterbi algorithm. The base form and surface form transcription aligner 320 generates a phone confusion matrix.

The system further contains a mixture tyer 330 associated with the base form and surface form transcription aligner 320 and configured to tie Gaussian mixture components across states. The illustrated embodiment of the mixture tyer 330 ties components as described above.

The system further contains a mixture weight retrainer and HMMs reestimator 340 associated with the mixture tyer 330 and configured to retrain mixture weights and reestimate the HMMs. The illustrated embodiment of the mixture weight retrainer and HMMs reestimator 340 retrains the acoustic models by first retraining mixture weights and transition probabilities. Then, the illustrated embodiment of the mixture weight retrainer and HMMs reestimator 340 trains all HMM parameters using the Baum-Welch E-M algorithm described above. The mixture weight retrainer and HMMs reestimator 340 generates the final GTM-HMMs.

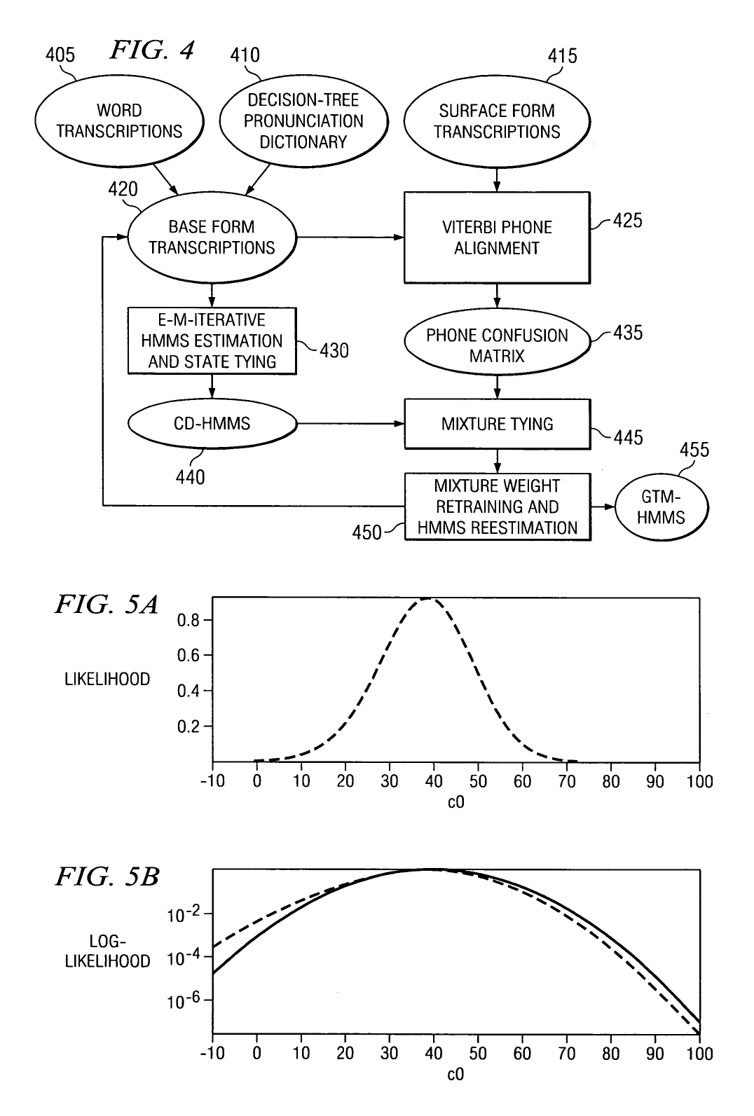

Turning now to FIG. 4, illustrated is a flow diagram of one embodiment of a method of creating generalized tied-mixture HMMs for noisy ASR carried out according to the principles of the present invention.

The method begins in a step 420 in which base form transcriptions are generated from word transcriptions 405 and a canonical word-to-phone dictionary or decision tree pronunciation dictionary 410 (see, e.g., Suontausta, et al., supra).

Surface form transcriptions are generated in a step 415. The surface form transcriptions may be obtained from a manual dictionary containing multiple pronunciations or a dictionary with different pronunciation from the canonical word-to-phone dictionary or decision tree pronunciation dictionary 410.

Base form and surface form transcriptions are aligned in a step 425 in the illustrated embodiment of the method, a dynamic programming alignment tool using the well-known Viterbi algorithm performs the base form and surface form alignment. A phone confusion matrix 435 is generated as a result.

E-M-iterative HMM parameter estimation and state-tying are carried out in a step 430. In doing so, state tying may be applied via decision-tree or data-driven approaches. CD-HMMs 440 are generated as a result.

Mixture tying occurs in a step 445. The exemplary techniques for mixture tying set forth above may be applied in this stage to tie Gaussian mixture components across states.

The acoustic models are retrained in a step 450. Mixture weights and transition probabilities may be retrained first. Then, all HMM parameters are advantageously trained using the Baum-Welch E-M algorithm described above. Other algorithms fall within the broad scope of the present invention, however. GTM-HMMs 455, which are the final models, are generated as a result.

Having described an exemplary system and method, results from experiments designed to explore the effectiveness of the GTM-HMMs for acoustic modeling will now be described. The experiments are based on a small-vocabulary digit recognition and a medium-vocabulary name recognition. For the experiments, features are 10-dimensional mel-frequency cepstral coefficient, or MFCC, feature vectors with cepstral mean normalization and delta coefficients thereof. A state-of-the-art baseline was obtained to provide a contrast with the GTM-HMM.

The HMM Toolkit, or HTK (publicly available from the Cambridge University Engineering Department, see, e.g., http://htk.eng.cam.ac.uk) can be used to implement the present invention. The HTK routines HDMan.c and HResult.c were modified to support the Viterbi alignment of pronunciation and phone confusion matrix. The HTK routine HHEd.c was also modified to support the generation of GTM-HMMs.

A decision-tree-based pronunciation model was trained from the well-known CMU dictionary (see, CMU, “The CMU Pronunciation Dictionary,” http://www.speech.cs.cmu.edu/cgi-bin/cmudict). Canonical pronunciations of the CMU dictionary were generated using decision trees. Then, Viterbi alignment was used to analyze phone confusion between the canonical pronunciation and the CMU dictionary.

Acoustic models were trained from the well-known Wall Street Journal (WSJ) database. Since the phone set of manual WSJ dictionary and CMU dictionary are different, the WSJ dictionary was transcribed using the decision-tree-based pronunciation model. Then, decision-tree-based state tying was used to obtain a baseline CD-HMM acoustic model for comparison.

Turning now to FIGS. 5A and 5B, illustrated are linear and logarithmic plots comparing the PDF of a GTM-HMM constructed according to the principles of the present invention and the PDF of a baseline CD-HMM.

By sharing mixtures across states, the GTM-HMM may have a different PDF in contrast to the normal PDF of a single-Gaussian PDF. FIGS. 5A and 5B plot the PDFs of a triphone “th-ah:m+m” at State 2, for both the GTM-HMM and the CD-HMM with a single Gaussian mixture component per state.

The PDF of the GTM-HMM is plotted using broken-line curve. The PDF of the CD-HMM is plotted in a solid-line curve. After training, the GTM-HMM selected mixtures from the triphones “z−ah+m,” “s−ay+ih,” “f−ah+dcl,” and “s−aa+dcl” and assigned different weights to them.

FIG. 5A suggests that the two PDFs overlap, but FIG. 5A's linear scale causes this misleading suggestion. The log-scale of FIG. 5B reveals that the PDF of the GTM-HMM is different from that of the CD-HMM. It should also be noticed that the GTM-HMM's PDF is asymmetric, in contrast to the CD-HMM is symmetric PDF. It therefore appears that the GTM-HMM is more discriminative than the CD-HMM and therefore yields better performance.

A series of tables will now set forth the results of experiments comparing the CD-HMM and the GTM-HMM under various driving conditions and training methods.

The results contained in Table 1 were obtained by recognizing 797 digit utterances collected under parked car conditions. Table 1 denotes the GTM-HMMs with or without pronunciation modeling (PM) as “GTM-HMM” and “GTM-HMM with PM.”

TABLE 1
Performance (%) of Digit Recognition
Achieved by Different Acoustic Models

| | | | GTM-HMM with |
|---|---|---|---|
| WER/SER | CD-HMM | GTM-HMM | PM |
| 1mix/state | 3.74/16.81 | 2.36/11.92 | 3.31/15.43 |
| 2mix/state | 3.19/14.68 | 2.74/13.17 | 2.45/11.92 |

The CD-HMM with one mixture per state had 6322 mean vectors and yielded a 3.74% WER. Increasing Gaussian mixture components to two mixtures per state decreased WER to 3.19%, but doubled the mean vectors to 12647. The GTM-HMM yielded a 2.36% WER for one mixture per state system and a 2.74% WER for two mixtures per state system, resulting in an overall 26% WER reduction.

The GTM-HMM with PM decreased WER to 3.31% for one mixture per state system and 2.45% WER for two mixtures per state system, resulting in an overall 17% WER reduction. Notice that these improvements were realized without any increase in model complexity.

For the next experiment, the CD-HMM was trained from the WSJ database with a manual dictionary. Decision-tree-based state tying was applied to train the gender-dependent acoustic model. As a result, the CD-HMM had one mixture per state and 9573 mean vectors. A pronunciation confusion matrix was obtained by analyzing the canonical pronunciation of the WSJ database generated from the same decision-tree-based pronunciation model as above. Testing was performed using a database containing 1325 English-name utterances collected in cars under different driving conditions. A manual dictionary with multiple pronunciations of these names was used for training.

The results are shown in Table 2, below, together with Error Rate Reduction (ERR). Table 2 shows that the CD-HMM performs acceptably under parked conditions, but degrades in recognition accuracy under highway conditions. In contrast, the GTM-HMM yielded a WER of 4.99% under highway conditions. In average, the GTM-HMM attained 21% WER reduction as compared to the CD-HMM. Incorporation of pronunciation variation into the GTM-HMM decreased WER by 7%.

TABLE 2
Performance (%) of Name Recognition Achieved
by Different Acoustic Models

| | | | GTM-HMM with |
|---|---|---|---|
| WER/SER | CD-HMM | GTM-HMM | PM |
| Parked | 0.35/0.42 | 0.28/0.38 | 0.33/0.42 |
| Stop and Go | 1.36/1.46 | 1.04/1.13 | 1.04/1.13 |
| Highway | 6.27/6.59 | 4.99/5.30 | 6.70/7.05 |
| Error Rate Reduction | | 21.3/17.2 | 7.5/5.2 |

For the next experiment, the IJAC system or method described in Yao (supra and incorporated herein by reference) for robust speech recognition was used to improve ASR. Table 3 shows the performances with and without IJAC. As expected, both the CD-HMM and the GTM-HMM performed better with IJAC.

TABLE 3
Performance (%) of Name Recognition Achieved
by Different Acoustic Models

| | | | GTM-HMM with |
|---|---|---|---|
| WER/SER (%) | CD-HMM | GTM-HMM | PM |
| Parked | 0.31/0.38 | 0.24/0.33 | 0.33/0.42 |
| Stop and Go | 1.21/1.32 | 0.96/1.07 | 0.96/1.07 |
| Highway | 4.98/5.23 | 3.52/3.71 | 4.38/4.64 |
| Error Rate Reduction | | 24.2/20.4 | 8.8/6.6 |
| (%) | | | |

For the next experiment, the mismatch in pronunciation was increased. The baseline CD-HMM and the GTM-HMM are the same as those used above. Instead of training the decision-tree-based pronunciation model from the CMU dictionary, the pronunciation model was trained from the WSJ dictionary. A difference from the experiments above was that the dictionary for testing was generated from the decision-tree-based pronunciation model and therefore the name dictionary for testing contained only a single pronunciation. This created a large mismatch of pronunciation between training and testing.

Table 4 shows the results. It is clearly seen that pronunciation mismatch caused the CD-HMM to perform unacceptably. Although degraded, the GTM-HMM still functions better than the CD-HMM. Pronunciation variation was then obtained by analyzing the WSJ dictionary and the decision-tree-based pronunciation model generated for the WSJ dictionary. With such pronunciation variation, the GTM-HMM with pronunciation variation reduced WER over all three driving conditions by 31%.

TABLE 4
Performance (%) of Name Recognition Achieved by Different Acoustic
Models Under Condition of Mismatched Pronunciation

| | | | GTM-HMM with |
|---|---|---|---|
| WER/SER (%) | CD-HMM | GTM-HMM | PM |
| Parked | 4.56/4.88 | 4.25/4.59 | 2.30/2.54 |
| Stop and Go | 9.65/10.10 | 8.15/8.52 | 7.29/7.64 |
| Highway | 20.36/20.94 | 17.24/17.90 | 16.43/17.02 |
| Error Rate Reduction | | 12.6/12.0 | 31.1/30.3 |
| (%) | | | |

For the last experiment, the accuracy of DTPM was increased by using the WSJ dictionary for training. IJAC was also used for improved noise compensation. Table 5 shows the results and further confirms that analysis of pronunciation variation improves ASR performance.

TABLE 5
Performance (%) of Name Recognition Achieved by Different Acoustic
Models Under Condition of Mismatched Pronunciation

| | | | GTM-HMM with |
|---|---|---|---|
| WER/SER | CD-HMM | GTM-HMM | PM |
| Parked | 3.01/3.34 | 3.01/3.34 | 1.97/2.21 |
| Stop and Go | 5.73/6.15 | 5.61/6.03 | 4.96/5.25 |
| Highway | 11.93/12.44 | 11.87/12.39 | 11.87/12.39 |
| Error Rate Reduction | | 0.9/0.8 | 16.2/16.3 |

Although the present invention has been described in detail, those skilled in the art should understand that they can make various changes, substitutions and alterations herein without departing from the spirit and scope of the invention in its broadest form.

What is claimed is:

1. A system for creating generalized tied-mixture hidden Markov models (HMMS) for noisy automatic speech recognition, comprising:
an HMM estimator and state tyer configured to perform HMM parameter estimation and state-tying with respect to word transcriptions and a pronunciation dictionary to yield continuous-density HMMs; and
a mixture tyer associated with said HMM estimator and state tyer and configured to tie Gaussian mixture components across states of said continuous-density HMMs and a phone confusion matrix thereby to yield said generalized tied-mixture HMMs.

2. The system as recited in claim 1 wherein said HMM estimator and state tyer is configured to perform said HMM parameter estimation by an E-M algorithm.

3. The system as recited in claim 1 wherein said HMM estimator and state tyer is configured to perform said state-tying by a selected one of:
a decision-tree approach, and
a data-driven approach.

4. The system as recited in claim 1 further comprising a base form and surface form transcription aligner associated with said HMM estimator and state tyer and configured to align base and surface form transcriptions to yield a phone confusion matrix.

5. The system as recited in claim 4 wherein said base form and surface form transcription aligner is embodied in a dynamic programming alignment tool using a Viterbi algorithm.

6. The system as recited in claim 1 further comprising a mixture weight retrainer and HMMs reestimator associated with said mixture tyer and configured to retrain mixture weights and reestimate said CD-HMMs thereby to yield said generalized tied-mixture HMMs.

7. The system as recited in claim 6 wherein said mixture weight retrainer and HMMs reestimator is configured to retrain said acoustic models by initially retraining said mixture weights and transition probabilities and subsequently using a Baum-Welch E-M algorithm.

8. A method of creating generalized tied-mixture hidden Markov models (HMMS) for noisy automatic speech recognition, comprising:
performing HMM parameter estimation and state-tying with respect to word transcriptions and a pronunciation dictionary to yield continuous-density HMMs; and
tying Gaussian mixture components across states of said continuous-density HMMs and a phone confusion matrix thereby to yield said generalized tied-mixture HMMs.

9. The method as recited in claim 8 wherein said performing comprises performing said HMM parameter estimation by an E-M algorithm.

10. The method as recited in claim 8 wherein said performing comprises performing said state-tying by a selected one of:
a decision-tree approach, and
a data-driven approach.

11. The method as recited in claim 8 further comprising aligning base and surface form transcriptions to yield a phone confusion matrix.

12. The method as recited in claim 11 wherein said aligning is carried out in a dynamic programming alignment tool using a Viterbi algorithm.

13. The method as recited in claim 8 further comprising:
retraining mixture weights; and
reestimating said CD-HMMs thereby to yield said generalized tied-mixture HMMs.

14. The method as recited in claim 13 wherein retraining comprises:
initially retraining said mixture weights and transition probabilities; and
subsequently using a Baum-Welch E-M algorithm.

15. A digital signal processor (DSP), comprising:
data processing and storage circuitry controlled by a sequence of executable instructions configured to:
perform hidden Markov models (HMM) parameter estimation and state-tying with respect to word transcriptions and a pronunciation dictionary to yield continuous-density HMMs; and
tie Gaussian mixture components across states of said continuous-density HMMs and a phone confusion matrix thereby to yield said generalized tied-mixture HMMs.

16. The DSP as recited in claim 15 wherein said HMM parameter estimation is performed by an E-M algorithm.

17. The DSP as recited in claim 15 wherein said state-tying is performed by a selected one of:
a decision-tree approach, and
a data-driven approach.

18. The DSP as recited in claim 15 wherein said sequence of executable instructions is further configured to align base and surface form transcriptions to yield a phone confusion matrix.

19. The DSP as recited in claim 18 wherein said sequence of executable instructions is at least partially embodied in a dynamic programming alignment tool using a Viterbi algorithm.

20. The DSP as recited in claim 15 wherein said sequence of executable instructions is further configured to:
retrain mixture weights; and
reestimate said CD-HMMs thereby to yield said generalized tied-mixture HMMs.

21. The DSP as recited in claim 20 wherein said sequence of executable instructions is further configured to retrain said acoustic models by initially retraining said mixture weights and transition probabilities and subsequently using a Baum-Welch E-M algorithm.
